(19) United States
(12) Patent Application Publication
(10) Pub. No.: US 2010/0235917 A1
(43) Pub. Date: Sep. 16, 2010

(54) SYSTEM AND METHOD FOR DETECTING SERVER VULNERABILITY

(76) Inventors: Young Bae Ku, Seoul (KR); Eui Won Park, Bucheon-si (KR); Chang Sup Ko, Seongnam-si (KR); Seung Wan Lee, Seoul (KR); Dong Hyun Kim, Seoul (KR); Ho Jin Jung, Seoul (KR); Sung Hoon Jin, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/471,021

(22) Filed: May 22, 2009

(30) Foreign Application Priority Data
May 22, 2008 (KR) 10-2008-0047552

(51) Int. Cl. G06F 11/00; G06F 17/30; G06F 15/16

(52) U.S. Cl. 726/25; 707/802; 709/206

(57) ABSTRACT

Systems and methods for detecting vulnerability of a server are provided. One system includes: a check server for collecting response information with respect to at least one predetermined command from one or more service servers that provide service, and thus may be attacked from outside, and detecting and analyzing vulnerabilities of the service servers based on the collected response information; an administration terminal for displaying the results of detecting and analyzing the vulnerabilities of the service servers; and a database for storing and managing pattern information concerning the detected vulnerabilities. One method includes identifying a server that may be attacked by port scanning, receiving response information with respect to at least one predetermined command from the identified server, detecting and analyzing vulnerability of the server based on the response information, and reporting the result of the detection to an administration terminal.

### CROSS-REFERENCE TO RELATED APPLICATION

This application claims the benefit under 35 U.S.C. §119 of Korean Patent Application No. 10-2008-0047552, filed May 22, 2008, which is hereby incorporated by reference in its entirety.

### BACKGROUND

1. Field

The present invention relates to a system and method for detecting vulnerability of a server providing a service.

2. Description of the Related Art

With development of the Internet, the number of web sites is sharply increasing, as is the number of servers providing services. However, these servers operate in different environments and require different functions. Thus, it is very difficult to keep their security levels uniform and manually check the security levels.

By taking advantage of these difficulties, hackers are able to intrude into vulnerable servers, upload malicious programs or files that they have created, and execute the uploaded programs or files at remote sites, thereby taking important information or modifying web sites. In this way, hackers can cause fatal damage to service providers. Further, these attacks are becoming a serious problem because they may damage not only the vulnerable server but also other servers in the same network.

However, programs or files created by hackers taking advantage of vulnerability of a server are not computer viruses or malicious code, and thus it is difficult to detect them using existing vaccine programs or malicious code detection programs. Thus, when a server is attacked, it is difficult for the corresponding service provider to recognize the attack before damage occurs. Even if the service provider recognizes the attack, in most cases, it is only after important information has already been leaked or a web site has been modified.

To prevent such damage, a check system which can detect vulnerabilities of servers, determine whether or not there is a problem in the servers, and cope with the problem is needed.

### BRIEF SUMMARY

The present invention is directed to a system and method for detecting vulnerability of a server, involving identifying a server that may be attacked by port scanning, receiving response information with respect to at least one predetermined command from the identified server, detecting and analyzing vulnerability of the server based on the response information, and thereby enabling efficient management of the vulnerability of the server.

The present invention is also directed to a system and method for detecting vulnerability of a server, involving identifying a server that may be attacked by port scanning, receiving response information with respect to at least one predetermined command from the identified server, detecting vulnerability of the server based on the response information, reporting the result of the detection to an administrator terminal, and thereby enabling prevention of damage to the server.

According to an aspect of an embodiment of the present invention, there is provided a system for detecting vulnerability of a server, including: a check server for collecting response information with respect to at least one predetermined command from one or more service servers that provide service and thus may be attacked from outside, and detecting and analyzing vulnerabilities of the service servers based on the collected response information; an administration terminal for displaying the result of detecting and analyzing the vulnerabilities of the service servers; and a database for storing and managing pattern information concerning the vulnerabilities of the service servers.

The check server may perform port scanning on service servers, identify the service servers that may be attacked from outside according to the result of the port scanning, transmit the at least one predetermined command to the identified service servers, collect the response information with respect to the transmitted command, and detect and analyze the vulnerabilities of the service servers based on the collected response information.

In a particular embodiment, the check server may identify service servers whose at least one port is open as the service servers that may be attacked from outside according to the result of the port scanning. In a further embodiment, the check server compares the response information with respect to the at least one predetermined command collected from the service servers with pattern information stored in the database, and detects and analyzes the vulnerabilities of the service servers according to the result of the comparison.

The command may be a command requesting access authorization to the service servers, a command requesting access to the service servers, or a command requesting a specific response, among other possibilities.

According to another aspect of an embodiment of the present invention, there is provided a system for detecting vulnerability of a server, including: a scanner for identifying at least one service server that provides service and thus may be attacked from outside; a collector for collecting response information received in response to one or more predetermined commands from the identified service servers; and an analyzer for detecting and analyzing vulnerability of the service servers based on the collected response information.

In one embodiment, the scanner performs port scanning on service servers providing service to identify a service server whose at least one port is open.

In a further embodiment, the collector sequentially transmits the predetermined commands to the identified service server and collects the corresponding response information.

In a further embodiment, the analyzer compares the response information collected from the service server with pattern information stored in a database, and detects and analyzes the vulnerability of the service server according to the result of the comparison. In a further embodiment, the analyzer stores the result of detecting and analyzing the vulnerability of the service server in the database, provides the result to an administration terminal such that an administrator can check the result, or transmits a notification message to the administrator.

According to still another aspect of an embodiment of the present invention, there is provided a method of detecting vulnerability of a server, including: storing and managing, at a check server, pattern information concerning vulnerabilities of one or more service servers; collecting, at the check server, response information received from at least one service server in response to at least one predetermined command; detecting and analyzing vulnerability of the service servers based on the collected response information; and displaying, at an administration terminal, the result of detecting and analyzing the vulnerability of the service servers.

In one embodiment, the detecting and analyzing of the vulnerability of the service servers includes: performing port scanning on the service servers to identify a service server that may be attacked from outside; transmitting a predetermined command to the identified service server; collecting response information received in response to the transmitted command; and detecting and analyzing the vulnerability of the service server based on the collected response information.

In a particular embodiment, the identifying of the service server includes identifying a service server whose at least one port is open.

In a further embodiment, the detecting and analyzing of the vulnerability of the service server further includes comparing the response information with respect to the predetermined command collected from the service server with the pattern information stored in the database, and detecting and analyzing the vulnerability of the service server according to the result of the comparison.

Here, again, the command may be a command requesting access authorization to the service server, a command requesting access to the service server, or a command requesting a specific response, among other possibilities.

According to yet another aspect of and embodiment of the present invention, there is provided a method of detecting vulnerability of a server, including: identifying at least one service server that provides service and thus may be attacked from outside; collecting response information received in response to one or more predetermined commands from the identified service server; and detecting and analyzing vulnerability of the service server based on the collected response information.

The identifying of the service server may include: performing port scanning on service servers providing service; and identifying a service server who's at least one port is open as the service server that may be attacked from outside according to the result of the port scanning.

In one embodiment, the collecting of the response information includes sequentially transmitting the predetermined commands to the identified service server that may be attacked from outside, and collecting the response information received in response to the transmitted commands.

In another embodiment, the detecting and analyzing of the vulnerability of the service server includes comparing the response information received from the service server in response to the predetermined commands with pattern information stored in a database and detecting and analyzing the vulnerability of the service server according to the result of the comparison.

In a further embodiment of the present invention, the method further includes storing the result of detecting and analyzing the vulnerability of the service server in the database, providing the result to an administration terminal such that an administrator can check the result, or transmitting a notification message to the administrator.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 schematically illustrates a system according to an exemplary embodiment of the present invention;

FIG. 2 is a block diagram of a check server such as the check server shown in FIG. 1 according to exemplary embodiment of the present invention;

FIG. 3 is a flowchart illustrating a method of detecting vulnerability of a server according to an exemplary embodiment of the present invention; and

FIG. 4 illustrates an example of a screen for displaying a check result according to an exemplary embodiment of the present invention.

### DETAILED DESCRIPTION

The present invention provides systems and methods capable of detecting and analyzing vulnerability of a service server providing service. Exemplary embodiments of the present invention involve identifying a server that may be attacked by port scanning, receiving response information with respect to at least one predetermined command from the identified server, detecting and analyzing vulnerability of the server based on the response information, and reporting the result of the detection to an administration terminal.

The subject matter of the present invention is described with specificity to meet statutory requirements. But this description is not intended to limit the scope of this patent. Rather, the inventors have contemplated that the claimed subject matter might also be embodied in other ways, to include different steps or combinations of steps similar to those described in this document, in conjunction with other present or future technologies.

Aspects of the invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, formats, and numerous other details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

The invention is described more fully hereinafter with reference to the accompanying drawings, in which embodiments of the invention are shown. The drawings are hereby incorporated in their entirety. This invention may, however, be embodied in many different forms and should not be construed as limited to the embodiments set forth herein. Rather, these embodiments are provided to fully enable those of ordinary skill in the art to embody and practice the invention.

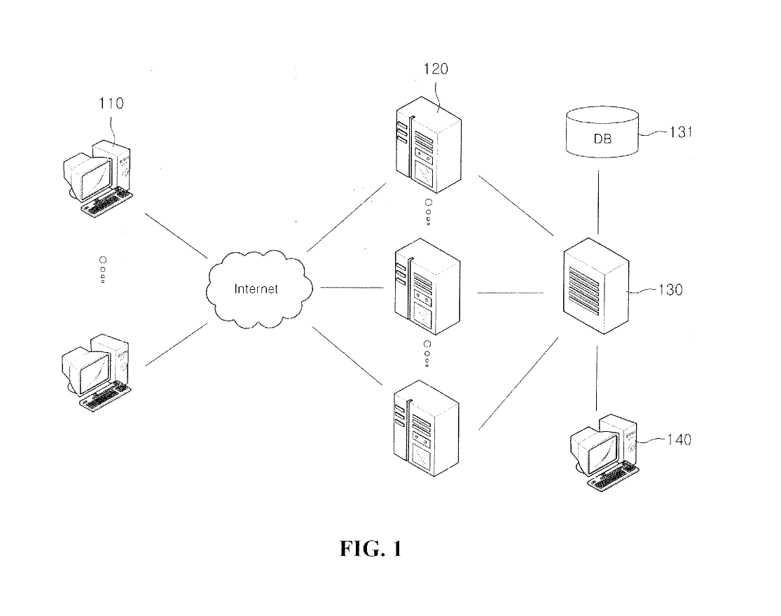

FIG. 1 schematically illustrates a system according to an exemplary embodiment of the present invention.

The system for detecting vulnerability of a server illustrated in FIG. 1 includes user terminals 110, service servers 120, a check server 130, a database (DB) 131, and an administrator terminal 140.

The service servers 120 provide various types of service through the Internet, and may include, for example, a web server, a content server, an image server, a file transfer protocol (FTP) server, and a DB server, among other possible services.

The check server 130 interoperates with the one or more service servers 120, periodically detect and analyze vulnerabilities of the interoperating service servers 120, and report the result to an administrator. In a particular embodiment, the check server 130 performs port scanning on the interoperating service servers 120, to identify a service server whose at least one port is open as a service server that may be attacked from outside. In a further embodiment, the check server 130 then collects response information received from the identified service server in response to at least one predetermined command and detects and analyzes the vulnerability of the service server based on the collected response information.

Port scanning is generally known in the art as a reconnaissance procedure for hacking, and denotes a technique of finding out which port is open or closed in a server having a specific Internet protocol (IP) address or domain name.

In an additional embodiment, the check server 130 stores the result of the detection and analysis in the DB 131, and also reports it to the administrator by transmitting, for example, an e-mail or a short message service (SMS) message to the administrator terminal 140 managed by the administrator. Other communication methods known in the art may also be used to transmit the report.

The administrator terminal 140 displays the result of detecting and analyzing the vulnerability of the server to enable the administrator to check it such that the administrator can correct the vulnerability of the service server based on the result of the detection and analysis. Also, the administrator can continuously check whether or not the vulnerability of the service server is corrected based on the detection and analysis result stored in the DB 131, and thus can thoroughly manage the security of the server.

As described above, an exemplary embodiment of the present invention identifies a server that can be attacked by port scanning, receives response information with respect to at least one predetermined command from the identified server, and detects and analyzes vulnerability of the server based on the response information, thereby enabling efficient management of the vulnerability of the server.

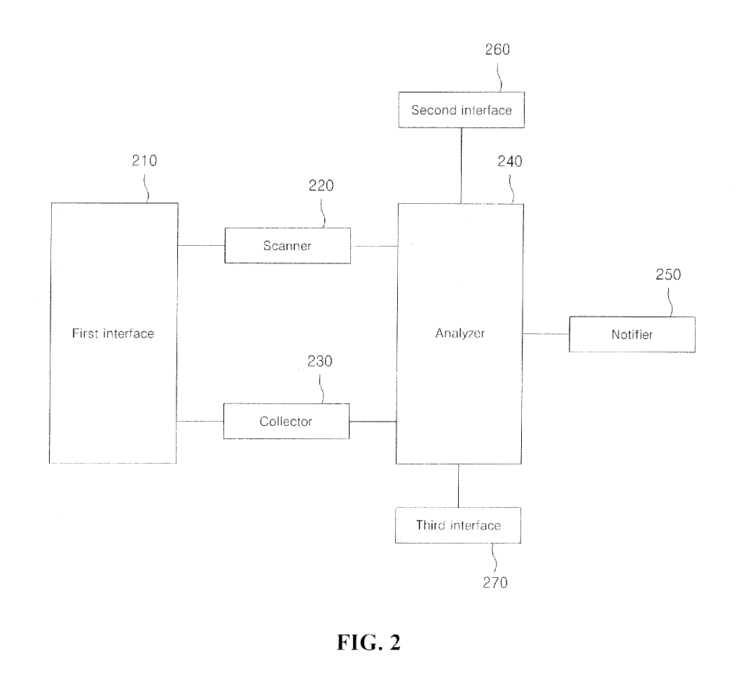

FIG. 2 is a block diagram of a check server such as the check server 130 shown in FIG. 1 according to an exemplary embodiment of the present invention.

The check server illustrated in FIG. 2 includes a first interface 210, a scanner 220, a collector 230, an analyzer 240, a notifier 250, a second interface 260, and a third interface 270.

The check sever 130 interoperates with at least one service server through the first interface 210, with an administrator terminal through the second interface 260, and with a DB through the third interface 270. In this way, the check server 130 may detect and analyze vulnerability of a service server, as described in detail below.

First, the scanner 220 identifies an accessible path. For example, the scanner 220 may perform port scanning on all interoperating service servers to identify a service server that may be attacked from outside based on the result of the port scanning.

When a service server that may be attacked from outside is identified, the collector 230 sequentially transmits one or more predetermined commands to the identified service server and collects response information with respect to the transmitted commands.

The analyzer 240 then detects and analyzes the vulnerability of the service sever based on the collected response information. In a further embodiment, the analyzer 240 compares the collected response information with pattern information stored in the DB, and detects and analyzes the vulnerability of the service server according to the result of the comparison. The pattern information may include information concerning vulnerabilities corresponding to service servers to be checked, and may be stored and managed in the DB.

In a further embodiment, the analyzer 240 stores the result of detecting and analyzing the vulnerability of the service server in the DB or provides the result to the administrator terminal, thereby enabling an administrator to properly cope with the result. In a particular embodiment, when the analyzer 240 requests the notifier 250 to transmit the result of detecting and analyzing the vulnerability of the service server to the administrator, the notifier 250 transmits the result to the administrator using e-mail, SMS, or another communication method known in the art.

As described above, an exemplary embodiment of the present invention identifies a server that can be attacked by port scanning, receives response information with respect to at least one predetermined command from the identified server, detects vulnerability of the server based on the response information, and reports the result of the detection to an administrator terminal, thereby enabling prevention of damage to the server.

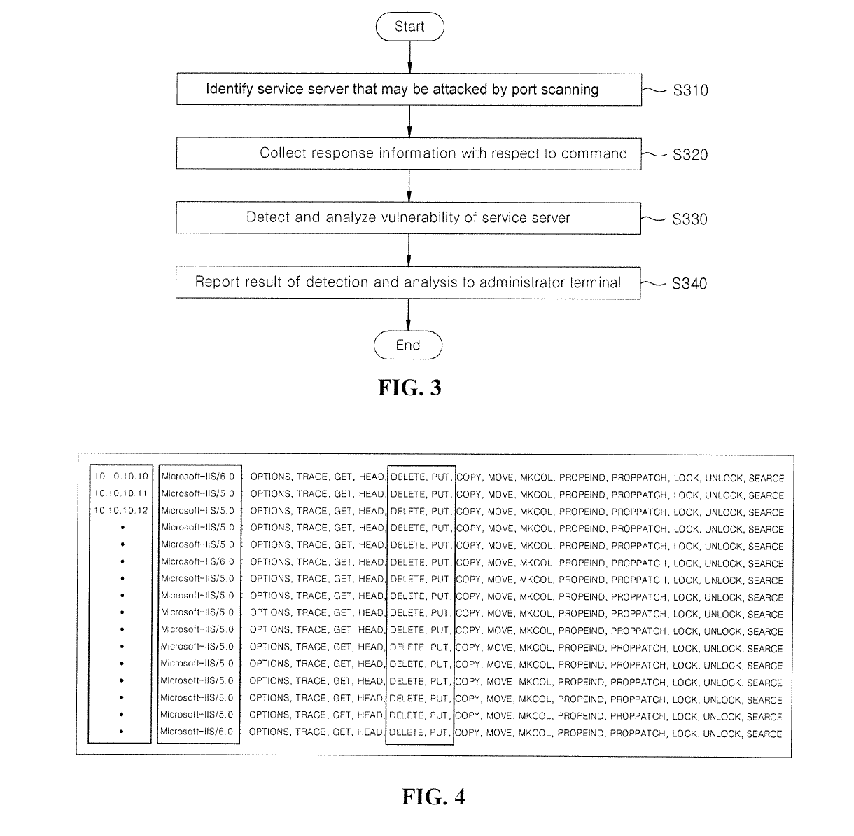

FIG. 3 is a flowchart illustrating a method of detecting vulnerability of a server according to an exemplary embodiment of the present invention.

As illustrated in FIG. 3, a check server such as the check server shown in FIG. 2 may identify a service server having an accessible path. For example, the check server may perform port scanning on all interoperating service servers and identify a service server that may be attacked from outside based on the result of the port scanning (S310).

In further embodiment, the check server first checks whether or not a specific service server is normally operating in connection with the Internet. In a particular embodiment, as shown in [Example 1] below, the check server uses a ping command to check whether or not the service server is normally operating in connection with the Internet based on the response.

### Example 1

Request: ping <service server's IP address>

Response: reply from <service server's IP address> bytes=32 time<1 ms TTL=128

A server that does not technically allow the ping command can be checked by port scanning.

In a further embodiment, after the check server determines that the service server is operating in connection with the Internet using the ping command, the check server checks whether at least one of all ports, e.g., ports numbered 0 to 65535, of the service server is open using socket communication. When the service server that may be attacked from outside is identified in this way, the check server may collect state information of the service server (S320).

In a particular embodiment, the check server transmits at least one command, for example, a command requesting access authorization, a command requesting access, or a command requesting a specific response to the service server, and collects response information with respect to the command. As shown in [Example 2] below, in one embodiment, access authorization to the web server can be requested in a command window, and response information may be collected.

### Example 2

Request: OPTION*HTTP/1.0

Host: <service server's IP address>

Response: Allow: PUT, DELETE, UPDATE

Using at least one such command for a web server, the check server may collect response information indicating whether it is possible to delete or modify information in the web server.

As shown in [Example 3] below, in another embodiment, response information can be collected by requesting access authorization to an FTP server in the command window. For example, the check server may check 1) whether the FTP server can be accessed from an anonymous account which can be used by any users, or 2) whether the FTP server can be accessed from an administrator account using a password, such as “root,” “admin,” or “administrator,” which can be easily guessed.

### Example 3

Request: ftp<service server's IP address>

User: <ID>

Password: <PW>

Response: user logged in

Using at least one such command for the FTP server, the check server may collect response information indicating whether it is possible to access the service server, that is, the FTP server.

As shown in [Example 4] below, in yet another embodiment, response information can be collected by requesting access to a DB server in the command window.

### Example 4

Request: SELECT*FROM sysusers

SELECT*FROM sysusers

Response: ODBC error, JDBC error

Using at least one such command for the DB server, the check server collects response information indicating whether it is possible to access the service server, that is, the DB server, or receive error information or requested information. In particular, the error information may be determined to indicate that the DB server is accessed, but an error regarding the command has occurred.

Subsequently, the check server may detect and analyze vulnerability of the service server based on the collected response information (S330). In a particular embodiment, the check server compares the collected response information with pattern information stored in a DB, and detects vulnerability of the service server according to the result of the comparison.

Finally, the check server provides the vulnerability of the service server to an administrator terminal (S340) such that an administrator can check correct the vulnerability of the service server. Details displayed on the administrator terminal in one embodiment of the present invention will now be described with reference to FIG. 4.

FIG. 4 illustrates an example of a screen for displaying a check result according to an exemplary embodiment of the present invention.

In the embodiment illustrated in FIG. 4, an administrator terminal displays information on the vulnerability of a service server received from a check server. Here, access authorization to the web server, including for example, writing and deleting authorization, is displayed. Thus, the administrator can see information concerning the service server having vulnerability and details on the vulnerability.

As described above, an exemplary embodiment of the present invention does not involve either detecting or analyzing vulnerability of a service server after accessing the service server. Rather, an exemplary embodiment of the present invention can readily detect and analyze vulnerability of a service server based on response information with respect to at least one predetermined command regardless of whether the service server is accessed or not.

The above-described method can be implemented as computer-readable code in a computer-readable recording medium. The computer-readable recording medium is any recording medium for storing data that can be read by a computer system. Examples of the computer-readable recording medium include a read-only memory (ROM), a random access memory (RAM), a compact disk-read only memory (CD-ROM), a magnetic tape, a floppy disk, and optical data storage. Alternatively, the medium may be implemented in the form of carrier waves (e.g., Internet transmission). In addition, the computer-readable recording medium may be distributed to computer systems connected via a network, and the computer-readable code may be stored and executed by a de-centralized method.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

Embodiments of the invention are not limited to the configurations and methods of the exemplary embodiments described above, and all or some of the exemplary embodiments may be selectively combined to yield variants. Many different arrangements of the various components depicted, as well as components not shown, are possible without departing from the spirit and scope of the present invention. Embodiments of the present invention have been described with the intent to be illustrative rather than restrictive. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims. Not all steps listed in the various figures need be carried out in the specific order described.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A system for detecting vulnerability of servers, comprising:
a check server, wherein the check server collects response information received from one or more service servers in response to at least one predetermined command and detects vulnerabilities of the one or more service servers based on the collected response information;
an administration terminal, wherein the administration terminal displays results of detecting vulnerabilities of the service servers; and
a database, wherein the database stores pattern information concerning the vulnerabilities of the service servers.

2. The system of claim 1, wherein the check server performs port scanning on a plurality of network servers, identifies the one or more service servers from among the plurality of network servers, and transmits the at least one predetermined command to the one or more service servers,
wherein the one or more service servers are identified because according to a result of the port scanning the check server determines that the one or more service servers may be attacked from outside.

3. The system of claim 2, wherein one of the one or more service servers is identified because according to the result of the port scanning the check server determines that at least one port on the one of the one or more service servers is open.

4. The system of claim 1, wherein the check server compares the response information with pattern information stored in the database and detects and analyzes the vulnerability of one of the one or more service servers according to a result of the comparison.

5. The system of claim 1, wherein one of the at least one predetermined command is selected from the group consisting of a command requesting access authorization to a service server, a command requesting access to the service server, and a command requesting a specific response.

6. A system for detecting vulnerability of servers, comprising:
a scanner for identifying at least one service server that provides service and thus may be attacked from outside;
a collector for collecting response information received from the at least one service server in response to one or more predetermined commands; and
an analyzer for detecting and analyzing vulnerability of the at least one service server based on the collected response information.

7. The system of claim 6, wherein the scanner performs port scanning on a plurality of network servers and according to a result of the port scanning identities a service server from among the plurality of network servers whose at least one port is open as one of the at least one service server that provides service and thus may be attacked from outside.

8. The system of claim 6, wherein the collector sequentially transmits the one or more predetermined commands to the at least one service server.

9. The system of claim 6, wherein the analyzer compares the response information with pattern information stored in a database and detects and analyzes the vulnerability of one of the at least one service server according to a result of the comparison.

10. The system of claim 6, wherein the analyzer stores a result of detecting and analyzing the vulnerability of the at least one service server in a database, provides the result to an administration terminal such that an administrator can check the result, or transmits a notification message based on the result to the administrator.

11. A method of detecting vulnerability of servers, comprising:
storing, in a database, pattern information concerning vulnerabilities corresponding to one or more service servers;
collecting, at a check server, response information from at least one service server in response to at least one predetermined command;
detecting and analyzing, at the check server, vulnerability of the at least one service server based on the collected response information; and
displaying, at an administration terminal, a result of detecting and analyzing the vulnerability of the service server.

12. The method of claim 11, wherein the detecting and analyzing of the vulnerability of the at least one service server comprises:
performing port scanning on a plurality of network servers;
determining, based on a result of the port scanning, that the at least one service server, among the plurality of network servers scanned, may be attacked from outside;
transmitting the at least one predetermined command to the at least one service server;
collecting the response information from the at least one service server in response to the at least one predetermined command; and
detecting and analyzing the vulnerability of the at least one service server based on the collected response information.

13. The method of claim 12, wherein the determining step comprises finding that at least one port on the at least one service server is open.

14. The method of claim 11 wherein the detecting and analyzing of the vulnerability of the at least one service server comprises comparing the response information with the pattern information stored in the database and detecting and analyzing the vulnerability of the at least one service server according to a result of the comparison.

15. A method of detecting vulnerability of a server, comprising:
identifying a service server that provides service and thus may be attacked from outside;
collecting response information from the identified service server in response to one or more predetermined commands; and
detecting vulnerability of the service server based on the collected response information.

16. The method of claim 15, wherein the identifying of the service server comprises:
performing port scanning on a plurality of network servers; and
determining, based on a result of the port scanning, that the service server, among the plurality of network servers scanned, may be attacked from outside.

17. The method of claim 15, further comprising sequentially transmitting the one or more predetermined commands to the identified service server.

18. The method of claim 15, wherein the detecting and analyzing of the vulnerability of the service server comprises:
comparing the response information with pattern information stored in a database; and
detecting and analyzing the vulnerability of the service server according to a result of the comparison.

19. The method of claim 15, further comprising storing the result of detecting and analyzing the vulnerability of the service server in a database, providing the result to an administration terminal such that an administrator can check the result, or transmitting a notification message based on the result to the administrator.

20. One or more computer-readable media having computer-useable instructions embodied thereon for performing a method of detecting vulnerability of servers, the method comprising:
storing, in a database, pattern information concerning vulnerabilities corresponding to one or more service servers;
collecting, at a check server, response information from at least one service server in response to at least one predetermined command;
detecting and analyzing, at the check server, vulnerability of the at least one service server based on the collected response information; and
displaying, at an administration terminal, a result of detecting and analyzing the vulnerability of the service server.

21. The media of claim 20, wherein the detecting and analyzing of the vulnerability of the at least one service server comprises:
performing port scanning on a plurality of network servers;
determining, based on a result of the port scanning, that at least one port on the at least one service server is open;
transmitting the at least one predetermined command to the at least one service server;
collecting the response information from the at least one service server in response to the at least one predetermined command; and
detecting and analyzing the vulnerability of the at least one service server based on the collected response information.

22. The media of claim 20, wherein the detecting and analyzing of the vulnerability of the at least one service server comprises comparing the response information with the pattern information stored in the database and detecting and analyzing the vulnerability of the at least one service server according to a result of the comparison.

23. One or more computer-readable media having computer-useable instructions embodied thereon for performing a method of detecting vulnerability of a server, the method comprising:
identifying a service server that provides service and thus may be attacked from outside;
collecting response information from the identified service server in response to one or more predetermined commands; and
detecting vulnerability of the service server based on the collected response information.

24. The media of claim 23, wherein the identifying of the service server comprises:
performing port scanning on a plurality of network servers; and
determining, based on a result of the port scanning, that the service server, among the plurality of network servers scanned, may be attacked from outside.

25. The media of claim 23, wherein the method further comprises sequentially transmitting the one or more predetermined commands to the identified service server.

26. The media of claim 23, wherein the detecting and analyzing of the vulnerability of the service server comprises:
comparing the response information with pattern information stored in a database; and
detecting and analyzing the vulnerability of the service server according to a result of the comparison.

27. The media of claim 23, wherein the method further comprises storing the result of detecting and analyzing the vulnerability of the service server in a database, providing the result to an administration terminal such that an administrator can check the result, or transmitting a notification message based on the result to the administrator.
